(19) United States
(12) Patent Application Publication
(10) Pub. No.: US 2012/0243751 A1
(43) Pub. Date: Sep. 27, 2012

(54) BASELINE FACE ANALYSIS

(76) Inventors: Zhihong Zheng, Lexington, MA (US); Rana el Kaliouby, Waltham, MA (US); Rosalind Wright Picard, Newtonville, MA (US); Panu James Turcot, Cambridge, MA (US)

(21) Appl. No.: 13/428,112

(22) Filed: Mar. 23, 2012

Related U.S. Application Data
(60) Provisional application No. 61/467,209, filed on Mar. 24, 2011.
(60) Provisional application No. 61/549,560, filed on Oct. 20, 2011.
(60) Provisional application No. 61/568,130, filed on Dec. 7, 2011.
(60) Provisional application No. 61/580,880, filed on Dec. 28, 2011.
(60) Provisional application No. 61/581,913, filed on Dec. 30, 2011.

(51) Int. Cl. G06K 9/62

(52) U.S. Cl. 382/118

(57) ABSTRACT

Facial information is collected on a person and used to analyze affect. Facial information can be used to determine a baseline face which characterizes the default expression that a person has on their face. Deviations from this baseline face can be used to evaluate affect and further be used to infer mental states. Facial images can be automatically scored for various expressions including smiles, frowns, and squints. Image descriptors and image classifiers can be used during this baseline face analysis.

### RELATED APPLICATIONS

This application claims the benefit of U.S. provisional patent applications “Baseline Face Analysis” Ser. No. 61/467,209, filed Mar. 24, 2011, “Mental State Analysis of Voters” Ser. No. 61/549,560, filed Oct. 20, 2011, “Mental State Evaluation Learning for Advertising” Ser. No. 61/568,130, filed Dec. 7, 2011, “Affect Based Concept Testing” Ser. No. 61/580,880, filed Dec. 28, 2011, and “Affect Based Evaluation of Advertisement Effectiveness” Ser. No. 61/581,913, filed Dec. 30, 2011. Each of the foregoing applications is hereby incorporated by reference in its entirety.

### FIELD OF INVENTION

This application relates generally to analysis of mental states and more particularly to baseline face analysis.

### BACKGROUND

Analysis of mental states is key to being able to understand an individual's responses to surrounding stimuli. The stimuli can range from watching videos, playing video games, interacting with websites, observing advertisements, to many other items near and far. Mental states run a broad gamut from happiness to sadness, from contentedness to worry, from excitement to calmness, as well as numerous others. These mental states are experienced in response to the stimuli already mentioned or to everyday events such as frustration during a traffic jam, boredom while standing in line, impatience while waiting for a cup of coffee, and as people interact with their computers and the internet.

### SUMMARY

Analysis of people may be performed by gathering mental states through evaluation of facial expressions, head gestures, and physiological conditions. The analysis of facial expressions depends on changes in those expressions. Determining a baseline face is crucial to identify a person's normal expression. Then when differences from this baseline face are encountered better analysis of the person's facial expressions is possible.

A computer implemented method is disclosed for facial analysis comprising: collecting a video of a face; grabbing a frame from the video of the face; projecting the face to a frontal view; scoring the frontal view wherein the scoring relates to a facial expression; and evaluating a baseline face from the scoring. The evaluating the baseline face may include evaluation of dynamic facial movements. The evaluating the baseline face may include determining positions to which a face tends to return. The method may further comprise determining positions to which a sub-region of the face tends to return. The evaluating the baseline face may include determining positions in which a face tends to spend a significant portion of time. The method may further comprise determining positions to which a sub-region of the face tends to spend a significant portion of time. The method may further comprise extracting sub-regions of the frontal view. The sub-regions may include one or more of a nose region, a mouth region, and an eyes region. A classifier may be used to evaluate one of the sub-regions. The sub-regions may be scored. The method may further comprise evaluating the frontal view using image descriptors. The image descriptors may include information on one of texture, edges, and color relating to the facial expression. The method may further comprise using image classifiers to label the frontal view based on aggregate statistics of the image descriptors. The baseline face may include a predominant set of facial expressions based on the scoring.

The method may further comprise further comprising analyzing a deviation from the baseline face. The deviation may include action unit identification. The method may further comprise further comprising evaluating affect based on the deviation. The evaluating affect may include inferring mental states. The method may further comprise detecting landmarks on the face within the frame. The method may further comprise performing feature extraction based on the landmarks which were detected. The landmarks on the face may include one or more from a group comprising eye corners, mouth corners, and brows. The scoring may provide a probability of the facial expression occurring. The facial expression may be one of a group including smiles, brow furrows, squints, lowered eyebrows, raised eyebrows, smirks, and attention. The facial expression may be associated with a mental state. The method may further comprise performing face detection on the frame. The method may further comprise aligning the face within the frame. The scoring may be adapted to an individual subject. The scoring may be based on detecting a plurality of action units. The method may further comprise discarding the frame if the face is not detected. The method may further comprise removing noisy frames. The projecting may provide a two-dimensional view of the face in the frontal view. The video of the face may include an angled view of the face. The method may further comprise collecting one or more additional videos of the face and building a multidimensional view of the face. One of a group comprising electrodermal activity, heart rate, and respiration may be used to help evaluate the baseline face.

In embodiments, a computer implemented method for facial analysis may comprise: collecting images of a face; identifying a baseline face for the face; analyzing deviations from the baseline face; and evaluating affect based on the deviations from the baseline face. The affect may be associated with a mental state. The deviations may include action unit identification. The method may further comprise scoring the face for the deviations and determining a probability of a facial expression occurring. The facial expression may be one of a group comprising a smile, a brow furrow, and a squint.

In some embodiments, a computer program product stored on a non-transitory computer-readable medium for facial analysis may comprise: code for collecting a video of a face; code for grabbing a frame from the video of the face; code for projecting the face to a frontal view; code for scoring the frontal view wherein the scoring relates to a facial expression; and code for evaluating a baseline face from the scoring. In embodiments, a computer system for facial analysis may comprise: a memory for storing instructions; one or more processors attached to the memory wherein the one or more processors are configured to: collect a video of a face; grab a frame from the video of the face; project the face to a frontal view; score the frontal view wherein the scoring relates to a facial expression; and evaluate a baseline face from the scoring. In some embodiments, a computer program product stored on a non-transitory computer-readable medium for facial analysis may comprise: code for collecting images of a face; code for identifying a baseline face for the face; code for analyzing deviations from the baseline face; and code for evaluating affect based on the deviations from the baseline face. In embodiments, a computer system for facial analysis may comprise: a memory for storing instructions; one or more processors attached to the memory wherein the one or more processors are configured to: collect images of a face; identify a baseline face for the face; analyze deviations from the baseline face; and evaluate affect based on the deviations from the baseline face.

Various features, aspects, and advantages of numerous embodiments will become more apparent from the following description.

### BRIEF DESCRIPTION OF THE DRAWINGS

The following detailed description of certain embodiments may be understood by reference to the following figures wherein:

FIG. 1 is a flow diagram for facial scoring.

FIG. 2 is a flow diagram for baseline face evaluation.

FIG. 3 shows an image collection system for facial analysis.

FIG. 4 shows an example probability of smile occurrence across time.

FIG. 5 shows an example histogram of smile probabilities.

FIG. 6 shows example facial expressions.

FIG. 7 is a flow diagram for using deviations from a baseline face.

FIG. 8 is a system diagram for analyzing mental state information.

### DETAILED DESCRIPTION

The present disclosure provides a description of various methods and systems for analyzing people's mental states particularly as their facial expressions change. A baseline face is the normative face for an individual. It is different from the neutral face which is just a muscle-relaxed face. Instead the baseline face is the face which a person typically has as a default expression. Identifying differences from this baseline face is critical to understanding and evaluating actual mental states. A mental state may be an emotional state or a cognitive state and these can be broadly covered using the term affect. Examples of emotional states include happiness or sadness. Examples of cognitive states include concentration or confusion. Observing, capturing, and analyzing these mental states can yield significant information about people's reactions to a videos. Some terms commonly used in evaluation of mental states are arousal and valence. Arousal is an indication on the amount of activation or excitement of a person. Valence is an indication on whether a person is positively or negatively disposed. Affect may include analysis of arousal and valence. Affect may also include facial analysis for expressions such as smiles or brow furrowing. Analysis may be as simple as tracking when someone smiles or when someone frowns while viewing a video.

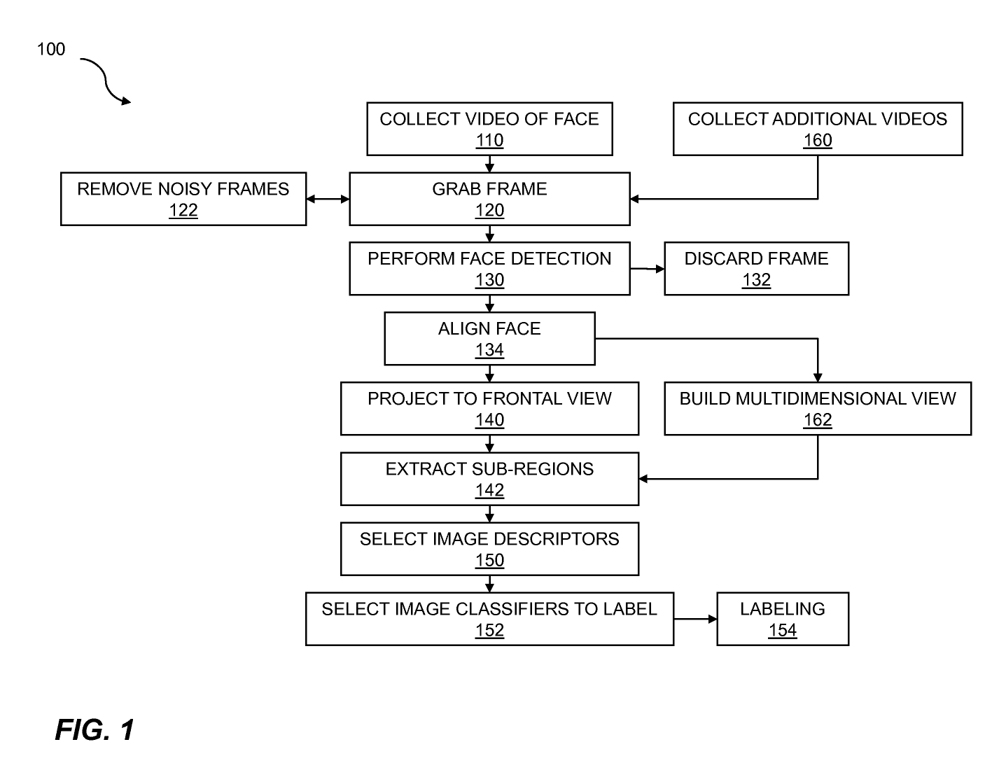

FIG. 1 is a flow diagram for facial scoring. A flow 100 is given for a computer implemented method for facial analysis. The flow 100 begins with collecting a video of a face 110. The collecting may include image capture by video camera, web camera still shots, thermal imager, CCD devices, phone camera, or other camera type apparatus. The flow 100 continues with grabbing a frame 120 from the video of the face. In some embodiments, noisy frames are detected and the flow 100 further comprises removing the noisy frames 122. A noisy frame may be a frame that includes smudging, smearing, fog, excessive pixilation, or the like. The flow 100 may continue with performing facial detection on the frame 130. The facial detection may be performed by analyzing the presence of eyes, nose, mouth, or other aspects of a face. The flow 100 may include discarding the frame 132 if a face is not detected. When a face is detected, the flow 100 may continue with aligning the face 134 within the frame. The aligning may include centering the face based on the location of eyes, mouth, and other features of the face.

The flow 100 continues with projecting the face to a frontal view 140. The projecting may provide a two-dimensional view of the face in the frontal view and may modify the face into a consistent two-dimensional image, performing flattening and adjusting of the face where needed. In some embodiments, adjustments are made to the facial image to compensate for the head being rotated or tilted to some extent. In embodiments, the flow 100 may further comprise extracting sub-regions 142 of the frontal view. In some embodiments, a sub-region can be a whole face. A sub-region may be the mouth, the eyes, the eyebrows, or some other portion of the face. The flow 100 may continue with evaluating the frontal view using image descriptors which are selected 150. The image descriptors include information on one of texture, edges, and color relating to the facial expression. The image descriptors may include information on pixels or groups of pixels. In some embodiments, a group of pixels may be termed as a “patch.” An image descriptor provides a numeric or statistical representation of the data in the pixels. A group of image descriptors may be defined or developed. From this group one or more image descriptors may be selected. In embodiments, local binary patterns (LBP) are used as an image descriptor. LBP uses a technique of dividing a window into cells which are in turn composed of pixels. Each pixel is compared with its eight immediate neighbors to generate an eight digit binary number based on pixel comparison. In embodiments, histogram oriented gradients (HOG) are used as another image descriptor. HOG counts occurrences in a small portion of an image. In some embodiments, by combining LBP and HOG improved facial scoring analysis is possible. The flow 100 may continue with selecting image classifiers to use in labeling 154 the frontal view based on aggregate statistics of the image descriptors. Image classifiers may be used to analyze portions of the face that are composed of the pixels covered by the image descriptors. Image classifiers may include information on smiling, brow furrowing, or other facial expressions. A label may be included as a metadata tag identifying a specific point in time corresponding to a particular facial expression. There are numerous examples of possible image classifiers including random forests, random ferns, support vector machine (SVM), decision tree, and so on.

In some embodiments, collection of additional videos 160 may be performed. The video of the face may include an angled view of the face. In some embodiments, the flow 100 may include collecting one or more additional videos of the face and building a multidimensional view 162 of the face. The multidimensional view may be built from multiple views by multiple video cameras. The multidimensional view may be used to build a three dimensional computer model which may be rotated or oriented as desired. Various steps in the flow 100 may be changed in order, repeated, omitted, or the like without departing from the disclosed inventive concepts. Various embodiments of the flow 100 may be included in a computer program product embodied in a non-transitory computer readable medium that includes code executable by one or more processors.

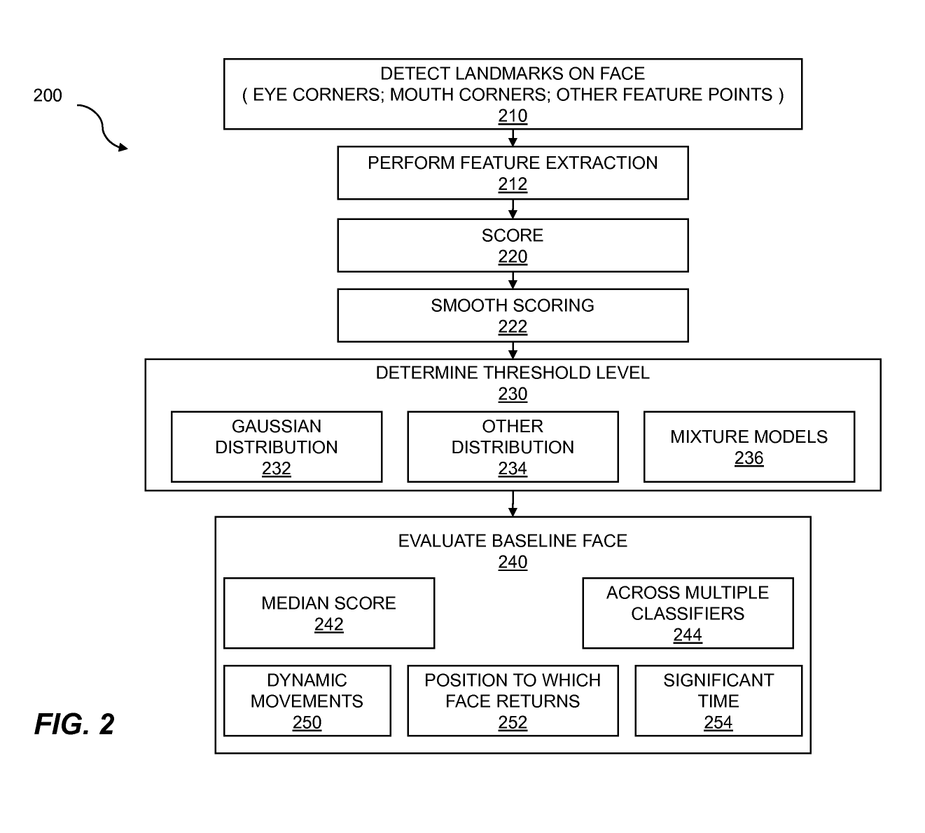

FIG. 2 is a flow diagram for baseline face evaluation. A flow 200 includes a computer implemented method for facial analysis. The flow 200 may be a continuation of the previously described flow 100. The flow 200 may include detecting landmarks on the face 210 within the frame. The facial landmarks may include the eye corners, the mouth corners, the nose, the brows, and other feature points or boundaries. The flow 200 may include performing feature extraction 212 based on the landmarks which were detected. The feature extraction may include identification and focus on specific image features in the region of the eyes, the eyebrows, the nose, the mouth, or the like. The extraction may include aggregation of local image descriptors in regions of interest.

The flow 200 may include scoring 220 the frontal view wherein the scoring 220 relates to a facial expression. The facial expression may be one of a group including smiles, brow furrows, squints, lowered eyebrows, raised eyebrows, smirks, and attention. The scoring 220 may provide a probability of the facial expression occurring. In some embodiments, the facial expression is associated with a mental state. For instance, a brow furrowing may be used to infer a state of confusion. In another instance, a smile may be used to infer a state of satisfaction. Many other possible mental states can be inferred from specific facial expressions or combinations thereof The scoring 220 may be done for multiple classifiers. In some embodiments, the flow 200 continues with smoothing of the scoring 222. The smoothing may be accomplished using un-weighted sliding average, cubic spline, exponential, moving average, or other types of smoothing. In some embodiments, the sub-regions may be scored.

The scoring may be based on detecting a plurality of action units (AU). The action units may include AU25 (lips part), AU27 (mouth stretch), AU24 (lip pressor), AU23 (lip tightener), AU20, (lip stretcher), AU17 (chin raiser), AU15 (lip corner depressor), AU12 (lip corner puller), AU09 (nose wrinkler), AU07 (lid tightener), AU06 (cheek raiser), AU05 (upper raiser), AU04 (brow lowerer), AU02 (outer brow raiser), AU01 (inner brow raiser), and others.

Based on the scoring, a threshold may be determined 230. The threshold analysis may include performing a distribution analysis of the scoring. The threshold may determine whether a smile, a frown, or other facial expression is occurring. During this process detection of a predominant set of scores may be performed by evaluating a classifier considering various distributions. A Gaussian distribution 232 may be used or other distribution model 234. Other distribution models may include a Poisson distribution as well as numerous others. In some embodiments, a mixture model 236 combining various distributions may be used. In some cases multiple Gaussian distributions may be combined in the form of a Gaussian mixture model (GMM). Machine learning techniques may be utilized to identify a distribution for a classifier and may be considered unsupervised learning. The threshold for a classifier could define where a smile was occurring, for instance. The threshold may also be determined by machine learning. The machine learning may be accomplished by having a specifically known set of scored images and having a computer system learn the correct scoring for facial expressions on those images. The known set of scored images may have been originally generated by a human expert or by a previous computer scored system that was known to be accurate. Using a set of images which are human scored for learning and may be considered supervised learning.

The flow 200 continues with evaluating a baseline face 240 from the scoring. The baseline face may include a predominant set of facial expressions based on the scoring. For instance, a sanguine person may have a baseline face which includes a smile to some extent. In another instance, a melancholy person may have a baseline face which includes a furrowed brow. A baseline face can be considered to be the predominant mode of the scored facial images. A combination of face portions may be used to make up the baseline face. The face portions may include the mouth, the eyes, the eyebrows, the nose, and other facial features. In embodiments, GMM provides a general method for obtaining the baseline face. The baseline face may be chosen based on the median scoring 242 point. The baseline face may be selected based on multiple classifiers 244 as the face may be best represented by multiple combined expressions. A dominant mode of distribution may be determined. The evaluating the baseline face may include evaluation of dynamic facial movements 250. By analyzing the motions of a face, trends for facial norms may be determined. The evaluating the baseline face may include determining positions to which a face tends to return 252. Once an obvious smile or obvious frown departs, for instance, the position which the face returns may be used to determine a baseline face. The flow 200 may further comprise determining positions to which a sub-region of the face tends to return. The evaluating the baseline face may include determining positions in which a face tends to spend a significant portion of time 254. By evaluating the expressions in which a face remains most of the time, a baseline face may be determined. In some embodiments, the flow 200 may include determining positions to which a sub-region of the face tends to spend a significant portion of time. Once a result for a baseline face is determined, the result may be evaluated as part of the machine learning.

In some embodiments, a series of images are obtained when a subject has not received external stimulation. This neutral setting may help identify the baseline face. In other embodiments, enough images are collected so that a baseline face can be established over time.

In some embodiments, image descriptors may not be used and the associated steps skipped. In this case direct pixel analysis is not required. The entire image will be operated on and image classifiers will be used to score the entire image or a portion thereof. In some embodiments, image classifiers may not be used and the associated steps skipped. In this case the pixel information or information on groups of pixels is operated on without the use of classifiers and the corresponding labels. A baseline face would then correspond to the numeric representation generated by the selected image descriptors. Determining a baseline without using a set of scored images to learn is considered unsupervised learning.

In some embodiments, one of a group comprising electrodermal activity, heart rate, and respiration may be used to help evaluate the baseline face. Electrodermal activity may be used to identify a low intensity of the expressions of interest. This low intensity may correspond to the baseline face. A decidedly typical condition may be detected using some physiological evaluation. This typical condition may be factored into the evaluation of when a baseline expression occurs. Furthermore, the scoring may be adapted to an individual subject. One person may have a baseline face and information on the baseline face may be fed back into the system and used to augment the scoring of facial expressions. Various steps in the flow 200 may be changed in order, repeated, omitted, or the like without departing from the disclosed inventive concepts. Various embodiments of the flow 200 may be included in a computer program product embodied in a non-transitory computer readable medium that includes code executable by one or more processors.

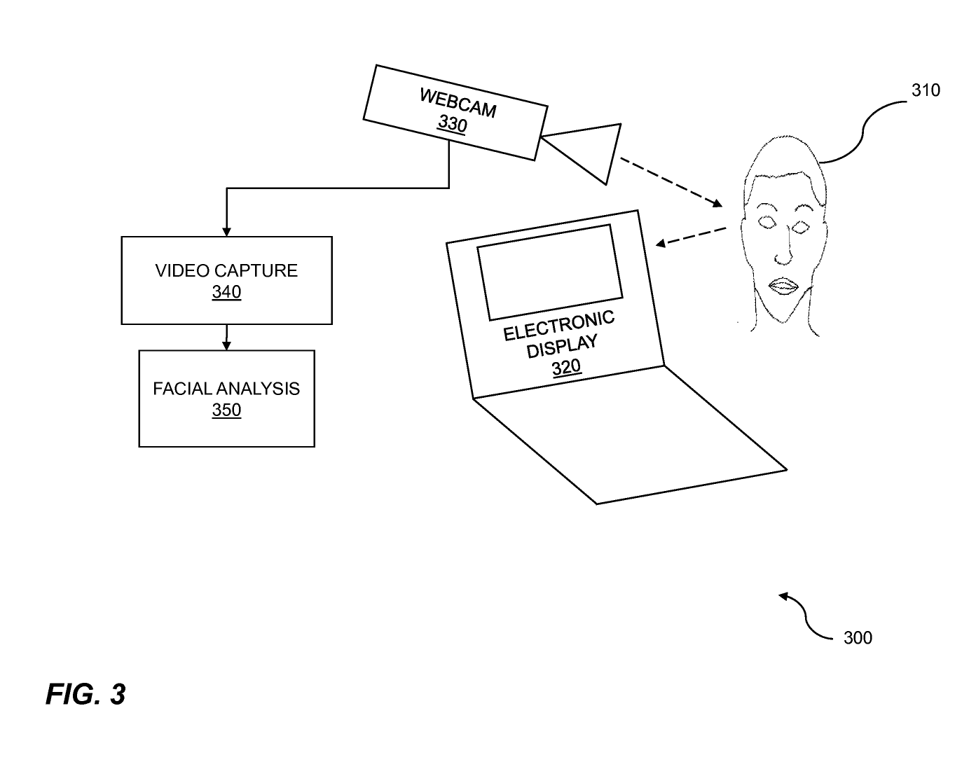

FIG. 3 shows an image collection system for facial analysis. A system 300 includes an electronic display 320 and a webcam 330. The system 300 captures facial response to the electronic display 320. In some embodiments, the system 300 captures facial responses to other stimuli such as a store display, an automobile ride, a board game, or other type experience. The facial data may include video and collection of information relating to mental states. In some embodiments, a webcam 330 may capture video of the person 310. Images of the person 310 may also be captured by video camera, web camera still shots, thermal imager, CCD devices, phone camera, or other camera type apparatus.

The electronic display 320 may show a video or other presentation. The electronic display 320 may include a computer display, a laptop screen, a mobile device display, a cell phone display, or some other electronic display. The electronic display 320 may include a keyboard, mouse, joystick, touchpad, wand, motion sensor, and other input means. The electronic display 320 may show a webpage, a website, a web-enabled application, or the like. The images of the person 310 may be captured by a video capture unit 340. In some embodiments, video of the person 310 is captured while in others a series of still images are captured. In embodiments, a webcam is used to capture the facial data.

Analysis of action units, gestures, and mental states may be accomplished using the captured images of the person 310. The action units may be used to identify smiles, frowns, and other facial indicators of mental states. The gestures, including head gestures, may indicate interest or curiosity. For example, a head gesture of moving toward the electronic display 320 may indicate increased interest or a desire for clarification. Based on the captured images, analysis of physiology may be performed. Facial analysis 350 may be performed based on the information and images which are captured. The analysis can include facial analysis and analysis of head gestures. The evaluating of physiology may include evaluating one of a group comprising heart rate, heart rate variability, respiration, perspiration, temperature, and other bodily evaluation. The evaluating one of a group comprising heart rate, heart rate variability, and respiration may be accomplished using a webcam. Additionally, in some embodiments, physiology sensors may be attached to the person to obtain further data on mental states.

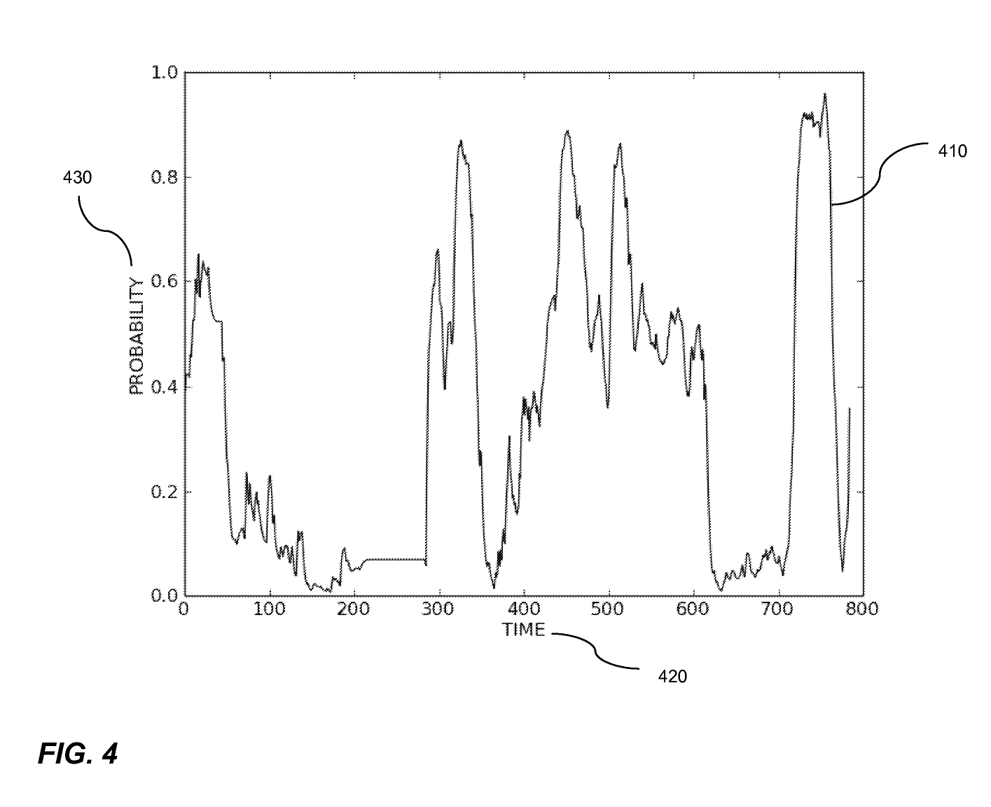

FIG. 4 shows an example probability of smile occurrence across time. A person is observed over a period of time. Their facial expressions are scored. The time 420 is shown as the x-axis on the graph. The time may be shown in seconds, minutes, or some other unit of time. In some embodiments, the time may be shown in terms of frame numbers from a video. The time could correspond to timing on a video watched, a game played, or some other activity. The scoring 430 is shown as the y-axis on the graph. The graph 410 shows results from the scoring. The scoring is for the probability that a facial expression occurs. At the peaks of the graph 410 a smile has high probability of occurrence. At the valleys of the graph 410 the probability of a smile is quite low. FIG. 4 is an example of graph for smiles. Similar graphs could be generated for brow furrows, squints, or other facial expressions.

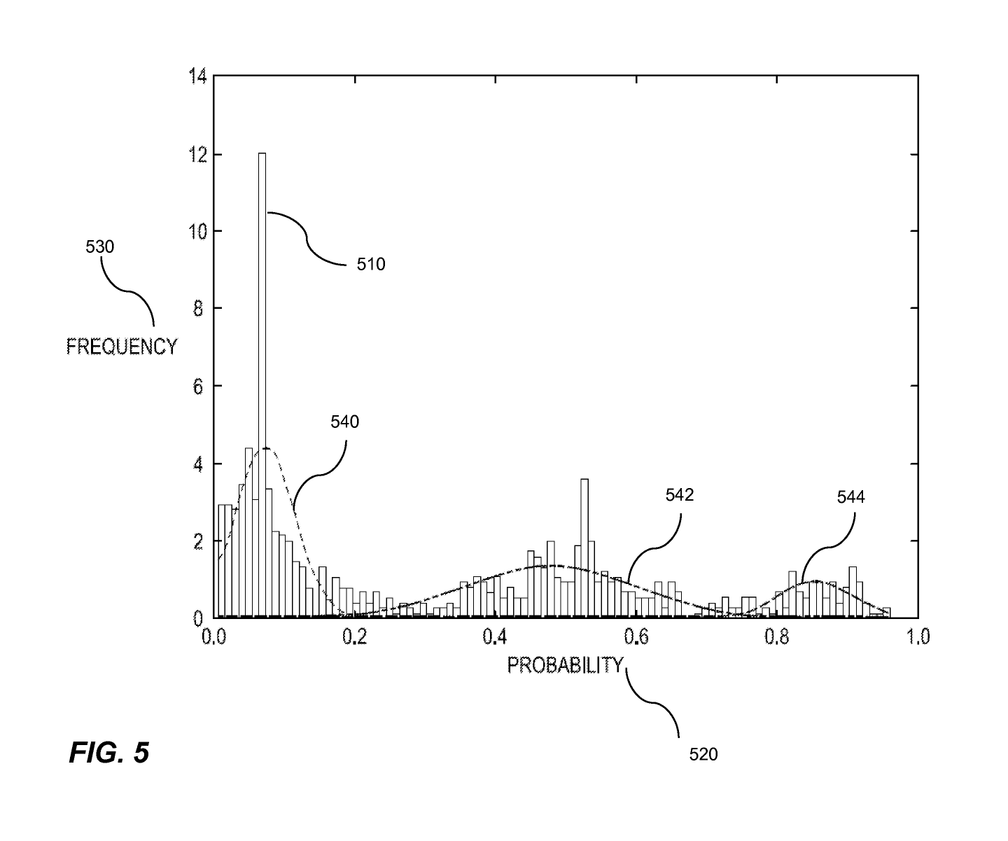

FIG. 5 shows an example histogram of smile probabilities. The histogram in FIG. 5 corresponds to the graph in FIG. 4. The probability 520 corresponds to the scoring in FIG. 4. The frequency 530 describes the number of occurrences of each probability shown in FIG. 4. The histogram 510 shows the various occurrences. The dominant expression is shown based on the curve 540. A second curve 542 and third curve 544 show other expressions that are not dominant. Therefore the baseline face would include the portion of the probability centered below a probability of 0.2. In this case, for the person being observed, the person's baseline face did not include a smile. In other instances, a person might be observed where the smile scoring shows a predominant feature of smile and therefore the baseline face included a smile. In this case, the histogram would be skewed toward the right hand with a dominant probability above 0.5.

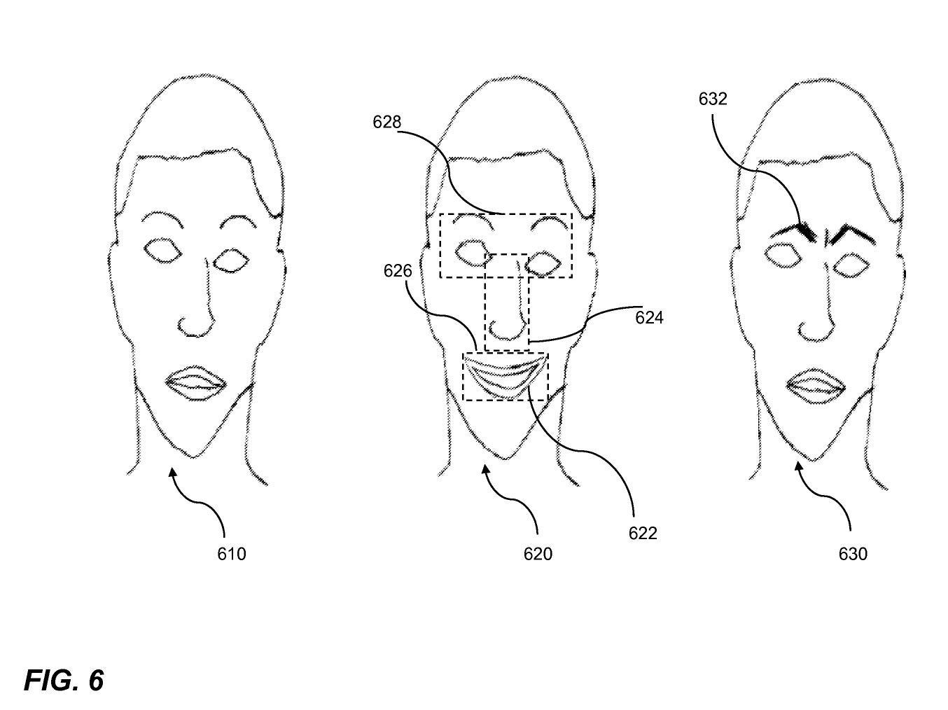

FIG. 6 shows example facial expressions. An example neutral face 610 may include no smile and no frown or other expression. With a neutral face, muscles are relaxed. An example smiling face 620 is shown. In some embodiments, a facial sub-region is identified and extracted. In embodiments, the sub-regions may include one or more of a nose region 624, a mouth region 626, and an eyes region 628. A classifier may be used to evaluate one of the sub-regions. A smile 622 is shown within the mouth sub-region 626. For some people, a baseline face of a smile may occur. An example frowning face 630 is shown with a furrowed brow 632 included. For some people, a baseline face of a furrowed brow 632 may occur.

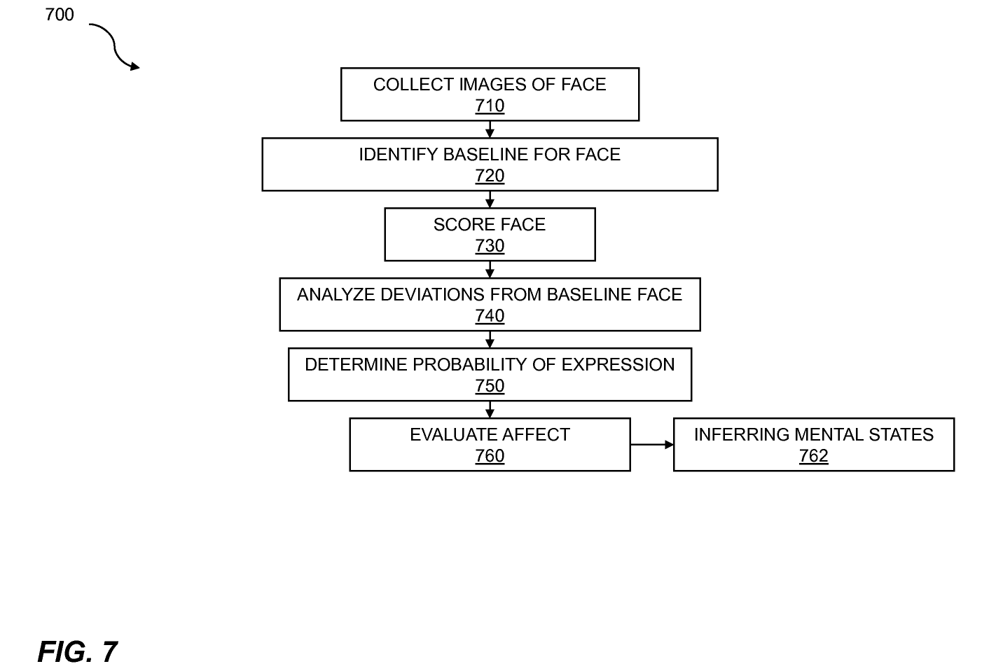

FIG. 7 is a flow diagram for using deviations from a baseline face. A flow 700 describes a computer implemented method for facial analysis. The flow 700 begins with collecting images of a face 710 for an individual. The collecting can be accomplished by video camera, webcam, still shots, thermal imager, CCD devices, phone camera, or other camera type apparatus. The flow 700 continues with identifying a baseline face 720 for the face of the individual. The baseline face is the normative face for an individual. It is different from the neutral face which is a muscle relaxed face. Instead, the baseline face is the face which a person typically has as a default expression. In some embodiments, the identifying a baseline face may simply be importing information on the baseline face for the individual. In this case, the baseline face has already been established for the individual. The facial expression may be one of a group comprising a smile, a brow furrow, and a squint as well as numerous others. The flow 700 may continue with scoring the face 730 for the deviations. In some embodiments, the scoring 730 may precede the identification of a baseline face 720 especially when that scoring is used in the effort to establish the baseline face. The flow 700 continues with analyzing deviations from the baseline face 740 based on the scoring. In some embodiments, the deviations include action unit identification. The flow 700 may continue with determining the probability of an expression 750 occurring based on the deviations.

The flow 700 continues with evaluating affect 760 based on the deviations. The evaluating affect may include inferring mental states 762. In embodiments, the affect may be associated with a mental state. In one example, a person's baseline face may be a smile. When particularly happily excited, the person's face may become an even broader smile. In this case the deviation would show the broader smile. The evaluating affect may be based on the deviations from the baseline face. Various steps in the flow 700 may be changed in order, repeated, omitted, or the like without departing from the disclosed inventive concepts. Various embodiments of the flow 700 may be included in a computer program product embodied in a non-transitory computer readable medium that includes code executable by one or more processors.

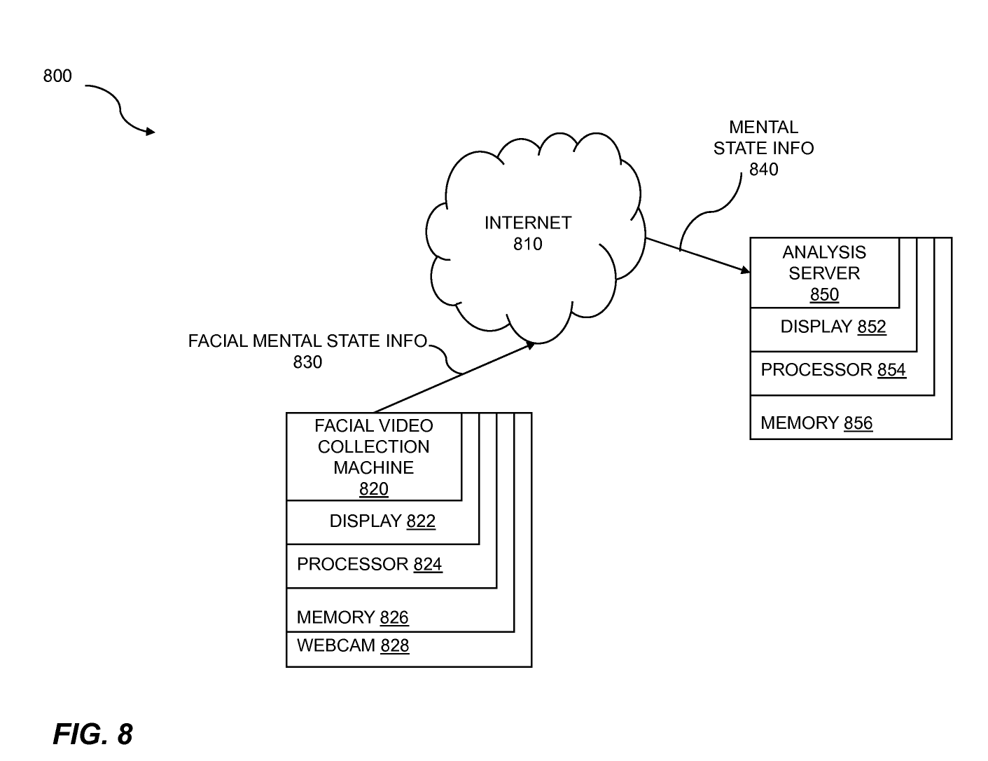

FIG. 8 is a system diagram for analyzing mental state information. The system 800 may include the Internet 810, intranet, or other computer network, which may be used for communication between or among the various computers of the system 800. A facial video collection machine or client computer 820 has a memory 826 which stores instructions, and one or more processors 824 connected to the memory 826 wherein the one or more processors 824 can execute instructions stored in the memory 826. The memory 826 may be used for storing instructions, for storing mental state data, for system support, and the like. The client computer 820 also may have an Internet connection to carry facial mental state information 830, and a display 822 that may present various videos to one or more viewers. The client computer 820 may be able to collect mental state data from one or more viewers as they observe the video or videos. In some embodiments there may be multiple client computers 820 that collect mental state data from viewers as they observe a video. The client computer 820 may have a camera, such as a webcam 828, for capturing viewer interaction with a video including, in some embodiments, video of the viewer. The camera may refer to a webcam, a camera on a computer (such as a laptop, a net-book, a tablet, or the like), a video camera, a still camera, a cell phone camera, a mobile device camera (including, but not limited to, a forward facing camera), a thermal imager, a CCD device, a three-dimensional camera, a depth camera, and multiple webcams used to capture different views of viewers or any other type of image capture apparatus that may allow image data captured to be used by the electronic system.

Once the mental state data has been collected, the client computer may upload information to an analysis server 850, based on the mental state data from the plurality of viewers who observe the video. The client computer 820 may communicate with the server 850 over the Internet 810, intranet, some other computer network, or by any other method suitable for communication between two computers. In some embodiments, the analysis server 850 computer functionality may be embodied in the client computer.

The analysis server 850 may have a connection to the Internet 810 to enable mental state information 840 to be received by the analysis computer 850. Further, the analysis server 850 may have a display 852 that may convey information to a user or operator, a memory 856 which stores instructions, data, help information and the like, and one or more processors 854 connected to the memory 856 wherein the one or more processors 854 can execute instructions. The memory 856 may be used for storing instructions, for storing mental state data, for system support, and the like. The analysis computer 850 may use the Internet 810, or other computer communication method, to obtain mental state information 840. The analysis server 850 may receive mental state information collected from a plurality of viewers from the client computer or computers 820, and may aggregate mental state information on the plurality of viewers who observe the video.

The analysis server 850 may process mental state data or aggregated mental state data gathered from a viewer or a plurality of viewers to produce mental state information about the viewer or plurality of viewers. In some embodiments, the analysis server 850 may obtain mental state information 830 from the client machine 820. In this case the mental state data captured by the client machine 820 was analyzed by the client machine 820 to produce mental state information for uploading. Based on the mental state information produced, the analysis server 850 may analyze a baseline face.

In at least one embodiment, a single computer may incorporate the client, server and analysis functionalities. The system 800 may include computer program product stored on a non-transitory computer-readable medium for facial analysis, the computer program product comprising: code for collecting a video of a face; code for grabbing a frame from the video of the face; code for projecting the face to a frontal view; code for scoring the frontal view wherein the scoring relates to a facial expression; and code for evaluating a baseline face from the scoring. The system 800 may include a memory for storing instructions along with one or more processors attached to the memory wherein the one or more processors are configured to: collect a video of a face; grab a frame from the video of the face; project the face to a frontal view; score the frontal view wherein the scoring relates to a facial expression; and evaluate a baseline face from the scoring.

The above methods may be executed on one or more processors on one or more computer systems. Embodiments may include various forms of distributed computing, client/server computing, and cloud based computing. Further, it will be understood that for the flow diagrams in this disclosure, the depicted steps or boxes are provided for purposes of illustration and explanation only. The steps may be modified, omitted, or re-ordered and other steps may be added without departing from the scope of this disclosure. Further, each step may contain one or more sub-steps. While the foregoing drawings and description set forth functional aspects of the disclosed systems, no particular arrangement of software and/or hardware for implementing these functional aspects should be inferred from these descriptions unless explicitly stated or otherwise clear from the context. All such arrangements of software and/or hardware are intended to fall within the scope of this disclosure.

The block diagrams and flow diagram illustrations depict methods, apparatus, systems, and computer program products. Each element of the block diagrams and flow diagram illustrations, as well as each respective combination of elements in the block diagrams and flow diagram illustrations, illustrates a function, step or group of steps of the methods, apparatus, systems, computer program products and/or computer-implemented methods. Any and all such functions may be implemented by computer program instructions, by special-purpose hardware-based computer systems, by combinations of special purpose hardware and computer instructions, by combinations of general purpose hardware and computer instructions, by a computer system, and so on. Any and all of which may be generally referred to herein as a “circuit,” “module,” or “system.”

A programmable apparatus which executes any of the above mentioned computer program products or computer implemented methods may include one or more processors, microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are not limited to applications involving conventional computer programs or programmable apparatus that run them. It is contemplated, for example, that embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized. The computer readable medium may be a non-transitory computer readable medium for storage. A computer readable storage medium may be electronic, magnetic, optical, electromagnetic, infrared, semiconductor, or any suitable combination of the foregoing. Further computer readable storage medium examples may include an electrical connection having one or more wires, a portable computer diskette, a hard disk, a random access memory (RAM), a read-only memory (ROM), an erasable programmable read-only memory (EPROM), Flash, MRAM, FeRAM, phase change memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. Each thread may spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the entity causing the step to be performed.

While the invention has been disclosed in connection with preferred embodiments shown and described in detail, various modifications and improvements thereon will become apparent to those skilled in the art. Accordingly, the spirit and scope of the present invention is not to be limited by the foregoing examples, but is to be understood in the broadest sense allowable by law.

1. A computer implemented method for facial analysis comprising:
collecting a video of a face;
grabbing a frame from the video of the face;
projecting the face to a frontal view;
scoring the frontal view wherein the scoring relates to a facial expression; and
evaluating a baseline face from the scoring.

2. The method of claim 1 wherein the evaluating the baseline face includes evaluation of dynamic facial movements.

3. The method of claim 1 wherein the evaluating the baseline face includes determining positions to which a face tends to return.

4. The method of claim 3 further comprising determining positions to which a sub-region of the face tends to return.

5. The method of claim 1 wherein the evaluating the baseline face includes determining positions in which a face tends to spend a significant portion of time.

6. The method of claim 5 further comprising determining positions to which a sub-region of the face tends to spend a significant portion of time.

7. The method according to claim 1 further comprising extracting sub-regions of the frontal view.

8. The method of claim 7 wherein the sub-regions includes one or more of a nose region, a mouth region, and an eyes region.

9. The method of claim 8 wherein a classifier is used to evaluate one of the sub-regions.

10. The method according to claim 7 wherein the sub-regions are scored.

11. The method according to claim 1 further comprising evaluating the frontal view using image descriptors.

12. The method according to claim 11 wherein the image descriptors include information on one of texture, edges, and color relating to the facial expression.

13. The method according to claim 11 further comprising using image classifiers to label the frontal view based on aggregate statistics of the image descriptors.

14. The method according to claim 1 wherein the baseline face includes a predominant set of facial expressions based on the scoring.

15. The method according to claim 1 further comprising analyzing a deviation from the baseline face.

16. The method according to claim 15 wherein the deviation includes action unit identification.

17. The method according to claim 15 further comprising evaluating affect based on the deviation.

18. The method according to claim 17 wherein the evaluating affect includes inferring mental states.

19. The method according to claim 1 further comprising detecting landmarks on the face within the frame.

20. The method according to claim 19 further comprising performing feature extraction based on the landmarks which were detected.

21. The method according to claim 19 wherein the landmarks on the face include one or more from a group comprising eye corners, mouth corners, and brows.

22. The method according to claim 1 wherein the scoring provides a probability of the facial expression occurring.

23. The method according to claim 1 wherein the facial expression is one of a group including smiles, brow furrows, squints, lowered eyebrows, raised eyebrows, smirks, and attention.

24. The method according to claim 1 wherein the facial expression is associated with a mental state.

25. The method according to claim 1 further comprising performing face detection on the frame.

26. The method according to claim 1 further comprising aligning the face within the frame.

27. The method according to claim 1 wherein the scoring is adapted to an individual subject.

28. The method according to claim 1 wherein the scoring is based on detecting a plurality of action units.

29. The method according to claim 1 further comprising discarding the frame if the face is not detected.

30. The method according to claim 1 further comprising removing noisy frames.

31. The method according to claim 1 wherein the projecting provides a two-dimensional view of the face in the frontal view.

32. The method according to claim 1 wherein the video of the face includes an angled view of the face.

33. The method according to claim 1 further comprising collecting one or more additional videos of the face and building a multidimensional view of the face.

34. The method according to claim 1 wherein one of a group comprising electrodermal activity, heart rate, and respiration is used to help evaluate the baseline face.

35-39. (canceled)

40. A computer program product stored on a non-transitory computer-readable medium for facial analysis, the computer program product comprising:
code for collecting a video of a face;
code for grabbing a frame from the video of the face;
code for projecting the face to a frontal view;
code for scoring the frontal view wherein the scoring relates to a facial expression; and
code for evaluating a baseline face from the scoring.

41. A computer system for facial analysis comprising:
a memory for storing instructions;
one or more processors attached to the memory wherein the one or more processors are configured to:
collect a video of a face;
grab a frame from the video of the face;
project the face to a frontal view;
score the frontal view wherein the scoring relates to a facial expression; and
evaluate a baseline face from the scoring.

42-43. (canceled)
